(19) United States
(12) Patent Application Publication
(10) Pub. No.: US 2007/0228861 A1
(43) Pub. Date: Oct. 4, 2007

(54) Electrical Rotary Machine and Electromagnetic Apparatus

(76) Inventor: Yukio Kinoshita, Minato-ku (JP)

Correspondence Address: DAY PITNEY LLP, 7 TIMES SQUARE, NEW YORK, NY, 10036-7311, US

(21) Appl. No.: 10/587,737

(22) PCT Filed: Jan. 28, 2005
(86) PCT No.: PCT/US05/03477

§ 371 Date: Jun. 11, 2007

(30) Foreign Application Priority Data
Jan. 28, 2004 (JP) 2004-019748

(51) Int. Cl. H02K 21/12

(52) U.S. Cl. 310/156.44; 310/156.01; 310/156.38

(57) ABSTRACT

A permanent magnet rotor (FIG. 2) includes a rotor core (41) and permanent magnets (5). The permanent magnet rotor is also formed with grooves (6) in order to reduce mangetic flux leakage.

### TECHNICAL FIELD

This invention relates to a magnetic pole structure for improving the performance and efficiency of electric motors and generators in electrical rotary machinery and mobile machinery that use magnets.

### PRIOR ART

Heretofore, in electric motors and generators in electrical rotary machinery that uses magnets, rotor magnets were arranged radially or in rings for use, but magnetic force of the magnets themselves were not utilized fully in the magnetic field in the air gap. Output and efficiency were determined inherently. In the era of conservation of resources and conservation of energy, there is also, without exception, a strong desire in the field of electric motors and generators for even higher efficiency and resource conservation, but adequately satisfactory equipment has not been developed.

As technological examples relating to such improvement, Japanese unexamined patent application publication (Kokai) No. 2000-154947 describes magnetoelectric motors and generators. In this patent, magnets in radial arrangement are used in electric motors and generators. Further, to increase performance, the length in the shaft direction of the rotor in which magnet is inserted is larger than the length in the shaft direction of the stator provided with winding, so that it is possible to increase magnetic flux in the air gap between stator and rotor.

Japanese unexamined patent application publication (Kokai) No. 2002-238193 describes another example of electric motor. In the electric motor in this patent, magnets in ringed arrangement are used. A rotor assembly is provided wherein multiplicity of permanent magnet sections are provided in the interior, the external periphery of this rotor has concave section provided in the part adjacent to the end section of the permanent magnet section. Air gap between the internal periphery of the stator and the external periphery of the rotor is enlarged at the part adjacent to the permanent magnet. In other words, because magnetic reluctance increases in this air gap, magnetic flux distribution between the internal periphery of the stator and the external periphery of the rotor approaches a sinusoidal wave and cogging torque is decreased.

### DISCLOSURE OF THE INVENTION

This invention has the objective of solving the problems of generating additional new driving force in conventional rotary force, by perceiving that increase in magnetic flux density in the air gap of rotor and stator in electric motors and generators, and arrangement of rotary magnetic field and magnets, and especially synchronous motors, have direct relationship to increased performance.

In this invention, means of solving the problems to achieve the aforementioned objective are explained in order as follows. Pursuant to the present invention, an electrical rotary machine using magnets comprising a rotor assembly facing a stator assembly for providing rotary driving force, said rotor assembly having a trailing edge portion for each of rotor magnetic pole configurations, said trailing edge portion adapted to have a strong magnetic field and create additional rotary driving force during synchronous rotation in association with both same and opposite magnetic poles of a stator facing the trailing edge portion of the rotor magnetic pole configuration.

In a first embodiment of the invention, an electrical rotary machine using a rotor, a stator and magnets is provided, wherein a rotary assembly is provided with radial or ringed magnets on insertion of magnets in the rotor, wherein each of magnetic pole configurations of the rotor is broad in width toward magnetic pole configurations of the stator along the rotation surface (stator pole width can be made small) and has a trailing edge portion maintaining relative positions with the stator magnetic pole configuration, constantly with during synchronous rotation, normally enabling suction and repulsion by means of the stator magnetic pole configurations opposing around the rotor magnetic pole trailing portions, whereby rotary driving force is additionally increased.

According to the first embodiment of the invention, an electrical rotary machine using a rotor, a stator and magnets, comprises radial or ringed magnets on insertion of magnets in the rotor, wherein magnetic pole configuration of said rotor is broad in width toward magnetic pole of said stator along the rotation surface (stator pole width can be made small), and each of the rotor magnetic pole configurations has a trailing edge portion constantly maintaining relative positions with relation with the stator magnetic pole configuration during synchronous rotation in the rotation direction of the rotor, normally enabling suction during rotation by the front stator magnetic pole by means of stator magnetic pole opposing around the trailing edge portion of the rotor magnetic pole configuration, and repulsion by means of the rear stator magnetic pole configuration, whereby rotary driving force is additionally increased. Resulting advantages are rapidly improving the performance and efficiency of electrical rotary machinery.

In a second embodiment of the invention, an electrical rotary machine using a rotor, a stator and magnets is provided, wherein each of rotor magnetic pole configurations comprising magnets does not have equiangular positioning but has varying angular pitch widths, wherein each of the rotor magnetic pole configurations has radial and ringed magnets on insertion of magnets in said rotor and a trailing edge portion including an air gap or non-magnetic member part around all of these magnets so that magnetic flux of ringed magnets of said rotor does not return directly to said rotor magnets, magnetic flux in the air gap is rapidly increased. This arrangement helps eliminating cogging without providing skew by relative deflection of angular positions toward stator magnetic pole comprising electromagnetic coupling. The trailing edge portion of each of the rotor magnetic pole configurations constantly maintains relative positions with the stator magnetic pole configuration during synchronous rotation and, enabling suction and repulsion during rotation by means of the stator magnetic pole configurations opposing against the trailing edge portions of the rotor magnetic pole configurations, rotary driving force is additionally increased.

In the second embodiment of the invention, an electrical rotary machine using a rotor, a stator and magnets is provided, wherein each of magnetic pole configurations of the rotor comprising magnets does not have equiangular positioning but has varying angular pitch widths to eliminate cogging without providing skew by relative deflection of angular positions toward stator magnetic pole comprising electromagnetic coupling, at the same time preventing decrease in magnetic flux. Each of the magnetic pole configurations of the rotor is provided with radial and ringed magnets on insertion of magnets in said rotor, and has an air gap or non-magnetic member part around said magnets at a trailing edge portion of each of the rotor magnetic pole configurations so that magnetic flux of ringed magnets of said rotor does not return directly to said rotor magnets, and devises increase in magnetic flux in the air gap of rotor and stator. The trailing edge portion of each of the rotor magnetic pole configurations constantly maintains relative positions with the stator magnetic pole configuration during synchronous rotation, normally enabling suction by the stator magnetic pole in front, by stator magnetic pole opposing front and rear of rotor magnetic pole trailing edge portion, and repulsion by the stator magnetic pole in rear, whereby additional rotary driving force can be normally implemented, the resultant effect rapidly improves the performance of electrical rotary machine.

In a third embodiment of the invention, an electrical rotary machine using a rotor, a stator and magnets is provided, wherein each of rotor magnetic pole configurations is provided with radial or ringed magnets on insertion of magnets in the rotor, and the rotor is subdivided into multiplicity of rows by being cut in round slices in the shaft direction of said rotor, one part of row comprising rotor structure is independently strengthened for use as a trailing edge portion of the rotor magnetic pole configurations, by operating at speed, constantly maintaining relative positions the stator magnetic pole configurations during synchronous rotation, normally enabling suction and repulsion by means of stator magnetic poles opposing front and rear of the trailing edge portions of the rotor magnetic pole configurations, whereby rotary driving force is additionally increased as possible.

In the third embodiment of the invention, an electrical rotary machine using a rotor, a stator and magnets is provided, wherein each of magnetic pole configurations of the rotor is provided with radial or ringed magnets on insertion of magnets in the rotor and wherein the rotor is subdivided into multiplicity such as cutting in round slices in the shaft direction of said rotor, wherein one part of subdivided rows in rotor is independently strengthened as a trailing edge portion of the rotor magnetic pole configuration and, at the time of synchronous operation, constantly maintains relative positions between the independently strengthened rotor magnetic pole trailing edge portions and the stator magnetic pole configuration, thereby normally enabling suction and repulsion by means of stator magnetic poles opposing front and rear of the trailing edge portion of the rotor magnetic pole configuration, the resultant effect is that of additionally increasing rotary driving force as possible.

In a forth embodiment of the invention, an electrical rotary machine using a rotor, a stator and magnets is provided, wherein the rotor is structured such that on insertion of magnets in the rotor, the interior sides relative to radial and ringed magnets have as same poles in the protruding part of rotor comprising part of magnet longer than length in shaft direction of the stator comprising iron core by electromagnetic coupling and the interior sides relative to radial and ringed magnets have opposite poles in the non-protruding part of rotor comprising part of magnet shorter than length in shaft direction of stator comprising iron core by electromagnetic coupling. Magnetic flux in the air gap at trailing edge portion of rotor magnetic pole configuration at iron core end section of the rotor is rapidly increased. The trailing edge portion of the rotor magnetic pole configuration constantly maintains relative positions with the stator magnetic pole configurations during synchronous rotation, normally enabling suction and repulsion very strongly by means of the stator magnetic pole configuration opposing front and rear of the trailing edge portion of the rotor magnetic pole configuration, whereby rotary driving force is additionally increased as possible.

In the fourth embodiment of the invention, an electrical rotary machine using a rotor, a stator and magnets is provided, wherein the rotor is structured such that on insertion of magnets in said rotor comprising magnets, such that the interior sides relative to radial and ringed magnets have same poles in the protruding part of rotor comprising part of magnet longer than length in shaft direction of stator comprising iron core by electromagnetic coupling, and the interior sides relative to radial and ringed magnets have opposite poles in the non-protruding part of rotor comprising part of magnet shorter than length in shaft direction of stator comprising iron core by electromagnetic coupling. It is possible to devise a large increase in magnetic flux in the air gap of the rotor and stator; the resultant effect is that of rapidly improving the performance and efficiency of electrical rotary machinery.

To make the above invention even more effective, and to display 100% performance and efficiency during synchronous electric motor operation, it is possible to obtain even better effect by separating prime mover and controller for actuation during the operation itself. Furthermore, it is also possible to obtain the effects of the invention by changing the stator magnet to winding, or changing stator winding to magnet, and effecting rotary magnetic field by a separate prime mover.

### BRIEF EXPLANATION OF THE DRAWINGS

The foregoing and other objects, advantages, effects and aspects of the invention will be better understood from the following detailed description of the invention with reference to the drawings, in which:

FIG. 1 is an illustration of an electrical rotary machinery according to Embodiment 1 of this invention.

FIG. 2 is a diagram of rotor 21 in Embodiment 1 of this invention.

FIG. 3 is a diagram of a conventional rotor.

FIG. 4 is a diagram of rotor 22 in Embodiment 2 of this invention.

FIG. 5 is a diagram of another conventional rotor.

FIG. 6A is a diagram of rotor 23 in Embodiment 3 of this invention.

FIG. 6B is a diagram of rotor 23 in Embodiment 3 of this invention.

FIG. 7 is a magnetic flux of rotor 24a, 24b, and magnetic flux of stator 3 in Embodiment 4 of this invention.

FIG. 8 is a diagram of rotor 24a in Embodiment 4 of this invention.

### DETAILED DESCRIPTION OF THE EMBODIMENTS

Several embodiments of this invention are explained below with reference to the drawings attached hereto.

### Embodiment 1

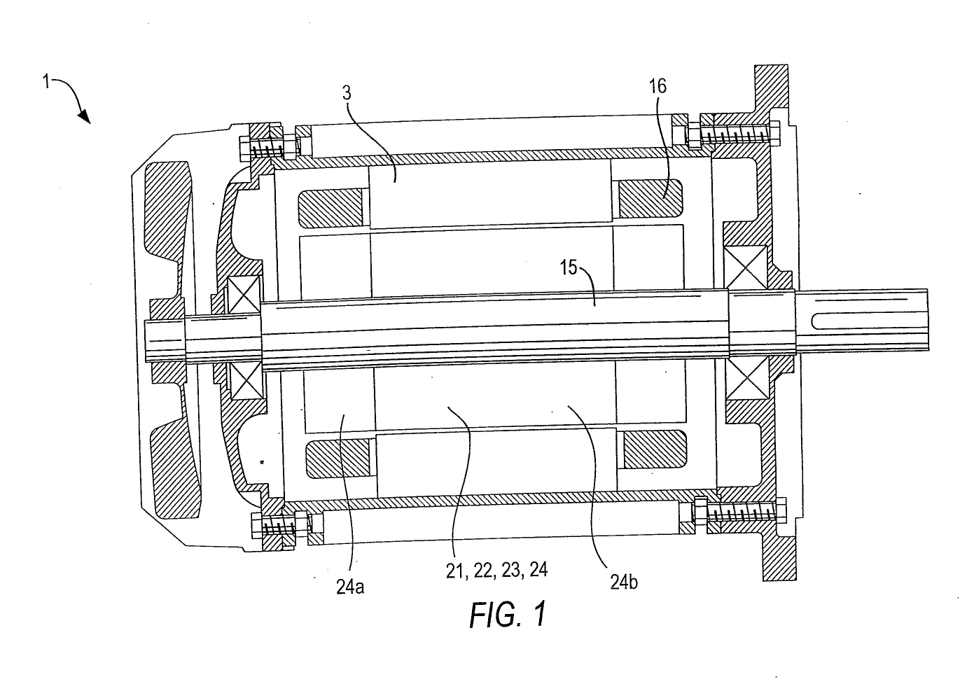

FIG. 1 shows electrical rotary machinery 1 of Embodiment 1, Embodiment 2, Embodiment 3, and Embodiment 4 of this invention. 21, 22, 23, 24 show rotor; 3, stator; 15, rotary shaft; 16, winding.

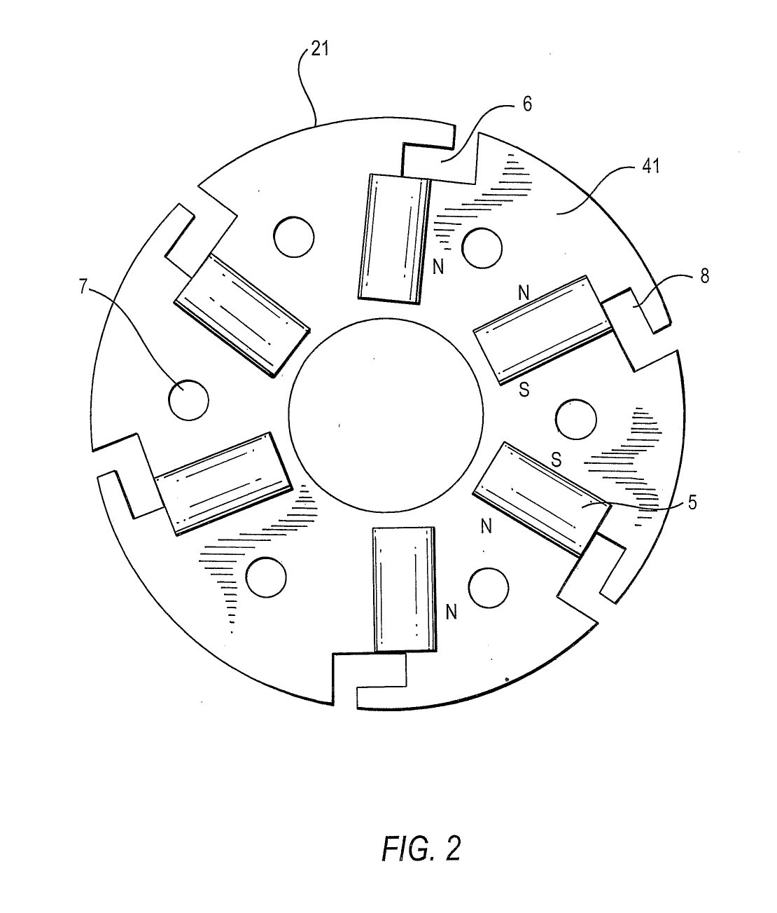

FIG. 2 shows Embodiment 1 of this invention. 21 shows rotor; 41 shows iron core magnetic pole comprising electromagnetic steel plate of rotor 21; 5 shows magnet of rotor 21. Magnetic pole 41 has configuration wherein magnet 5 is radially arranged. 6 shows groove; 7 shows attachment hole.

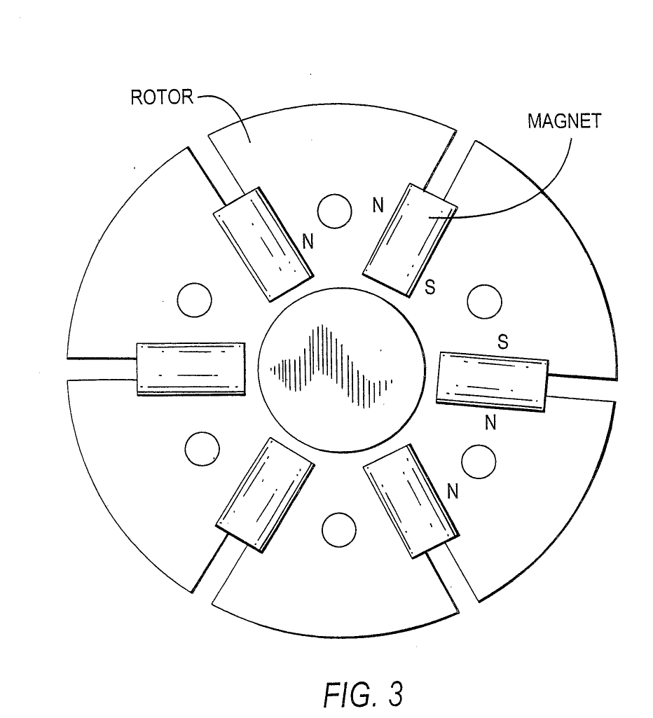

For reference, FIG. 3 shows one example of conventional rotor configuration provided with magnets in radial arrangement.

In magnetic pole 41 of rotor 21, in configuration where magnet 5 is arranged radially, one part 8 of configuration of magnetic pole 41 of rotor 21 has “protruding configuration” that is asymmetric. This area is called a trailing edge portion of each of rotor magnetic pole configuration which is adapted to have a strong magnetic field and create additional rotary driving force constantly during synchronous rotation in association with a stator magnetic pole configuration according to the invention. Conventionally, the configuration is symmetric as shown in FIG. 3. Furthermore, it is possible to layer rotor 21 by reverse rotation through attachment hole 7 of rotor 21. Therefore, the angle of magnetic pole 41 of rotor 21 is substantially widened. As the result, the spread toward magnetic pole of stator 3 not only deals relatively with same pole (or opposite pole), but also extends to the position dealing with the opposite pole (or same pole).

In the operation of generator or electric motor with electrical rotary machinery 1, when stator 3 and rotor 21 are in positions mostly with same poles (or opposite poles), repulsion (withdrawal) occurs; at the same time, the adjacent stator 3 and rotor 21 undergo repulsion (withdrawal) at a position in one part of the opposite pole; coupling of stator 3 and rotor 21 by relative action improves. When there is synchronous rotation in this situation, suction normally occurs between trailing edge portions 8 of rotor magnetic pole configuration and magnetic pole 41 and the opposing stator magnetic pole; further, repulsion can be normally made to occur with the rear stator magnetic pole; driving force of electrical rotary machinery 1 is additionally generated to devise improvement in performance; torque cogging phenomenon is reduced; the resultant effect is that of suppressing vibration.

### Embodiment 2

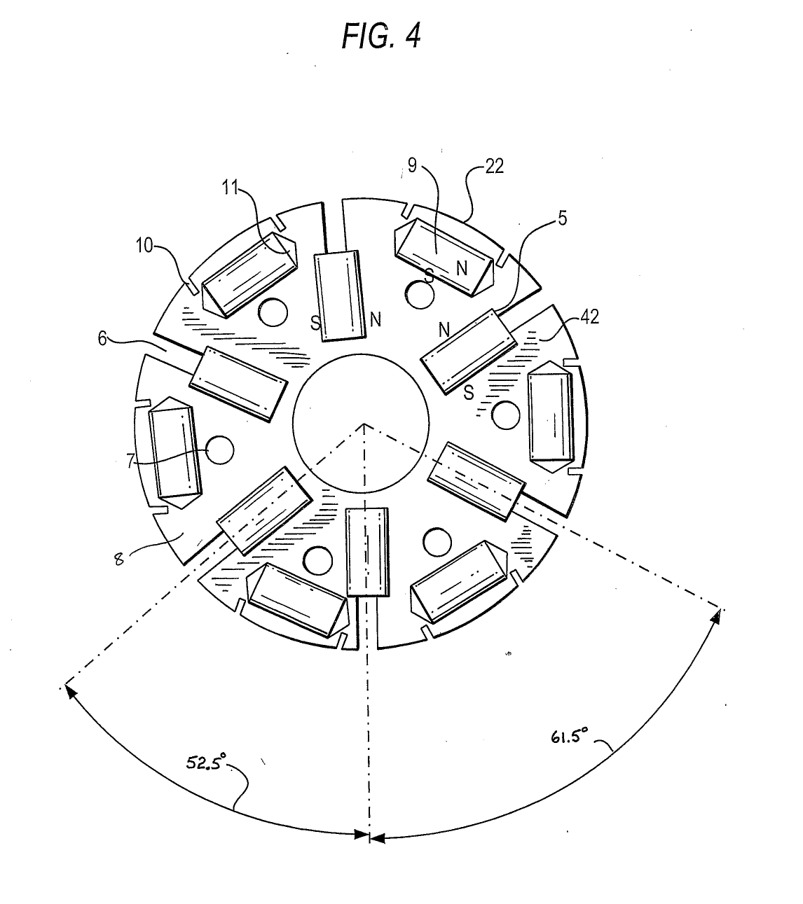

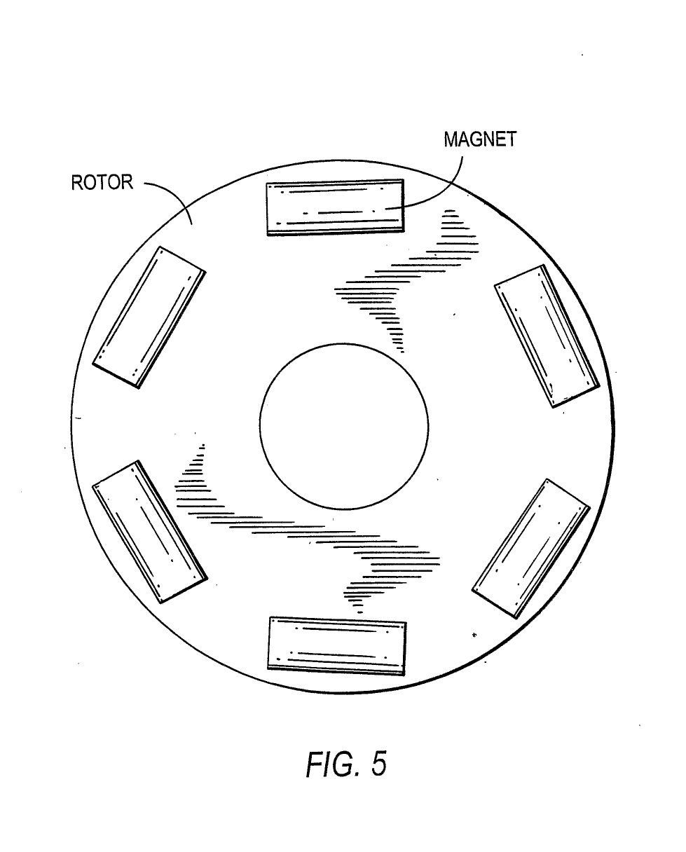

FIG. 4 shows Embodiment 2 of this invention. 22 shows rotor; 42 shows iron core magnetic pole comprising electromagnetic steel plate of rotor 22; 5 shows magnet of rotor 22. Furthermore, in magnetic pole 42, magnet 5 is arranged in radial configuration and at the same time, magnet 9 is arranged in ringed configuration; furthermore, grooves 10, 11 are provided in magnetic pole 42. For reference, FIG. 5 shows conventional rotor configuration provided with magnets in ringed arrangement.

Air gap or non-magnetic member part is provided in grooves 10, 11 around said magnet 9 so that magnetic flux of ringed magnet 9 of said rotor 22 does not return directly to magnet 9 of said rotor 22. By means of such structure, large increase in magnetic flux is devised in the air gap of rotor 22 and stator 3.

Furthermore, magnet 5 is positioned with same poles facing each other toward the adjacent magnet relative thereto. Magnetic pole 5 of rotor 21, in the case of pole 6, for example, does not have equiangular 60-degree arrangement; each pole of 5 poles has angular pitch of 60°×(180˜186)/180. The remaining one pole has the arrangement of 180°−5×60(180˜186)/180. On the other hand, magnetic pole of stator 3 in divided equally into 60 degrees for the 6 poles. Therefore, there is relative deflection of position toward magnetic pole of stator 3 from electromagnetic coupling so that rotor pole width is widened.

By such structure, when there is rotation at synchronous speed in this situation, suction normally occurs between rotor trailing edge portion magnetic pole section 8 and magnetic pole 41 and the opposing stator magnetic pole; further, repulsion can be normally made to occur with the rear stator magnetic pole; driving force of electrical rotary machinery 1 can be additionally generated to devise improvement in performance; torque cogging phenomenon is reduced; the result effect is that of suppressing vibration.

Further, radial slots are provided for insertion of magnet 5 in respective magnetic poles 42 comprising iron core magnetic poles, so that magnet 5 can have length adjusted in the radial direction. Because length of magnet 5 can be adjusted in the radial direction, and furthermore, radial slots are provided for insertion of magnet 5, in particular, when magnetic flux is strengthened, strong magnet and magnet filling the slot completely are used. Moreover, by having the structure wherein magnets 5, 9 are freely inserted and removed, it is possible to easily change or adjust properties of electric motors and generators.

### Embodiment 3

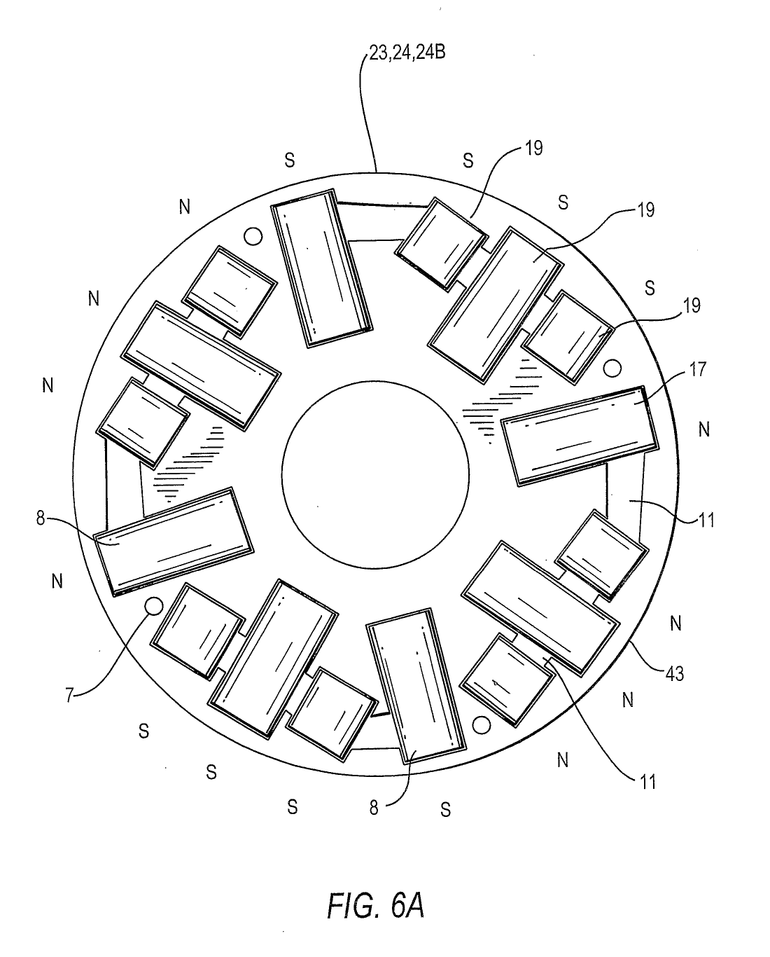

Embodiment 3 of this invention is shown in FIG. 6A and FIG. 6B. 23 shows rotor of pole 4; 43 shows iron core magnetic pole comprising electromagnetic steel plate of rotor 23.

In FIG. 6A, magnet 17 is arranged radially in magnetic pole 43 of rotor 23; magnet group 19 is arranged in ringed shape; air gap or non-magnetic member part is provided in space 11 around magnet 19.

This structure is an example where magnetic pole 43 constitutes magnet only. This magnetic pole 43 has structure wider than width of stator magnetic pole, and at the same time, directly deals with magnet that forms strong magnetic field at the trailing edge portion, thus large increase is devised in magnetic flux in air gap in rotor 2 and stator 3, and in addition, the configuration is such as to deflect coupling between magnetic poles of rotor 23 and stator 3, and effect layering in part.

It is clear that when stator magnetic pole width is made small in conjunction with this, it is even more effective.

By such structure, when there is rotation at synchronous speed in this situation, suction normally occurs between rotor trailing edge portion magnetic pole section 8 and magnetic pole 45 and the opposing stator magnetic pole; further, repulsion can normally occur with the rear stator magnetic pole; driving force of electrical rotary machinery 1 is additionally and rapidly generated; large improvement in performance is devised; torque cogging phenomenon is reduced; the resultant effect is that of suppressing vibration.

In FIG. 6B, in order to further strengthen the magnetic field of trailing edge portion 8 of rotor magnetic pole 44 formed by magnet 17 in FIG. 6A, the structure constitutes a small magnet 17 comprising iron core 23 which is independent and used exclusively for strengthening [the magnetic field]. By forming various arrangements in the shaft direction in combination with iron core 23 of FIG. 6A, additional driving force is adjusted at time of synchronous rotation; rapid improvement is possible.

### Embodiment 4

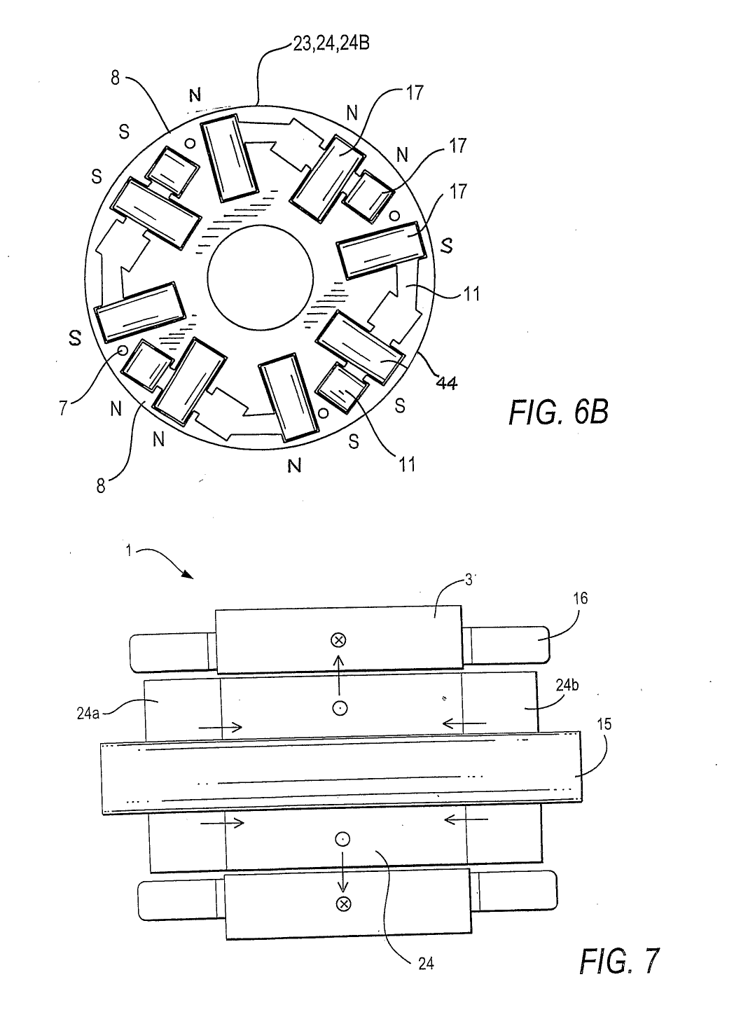

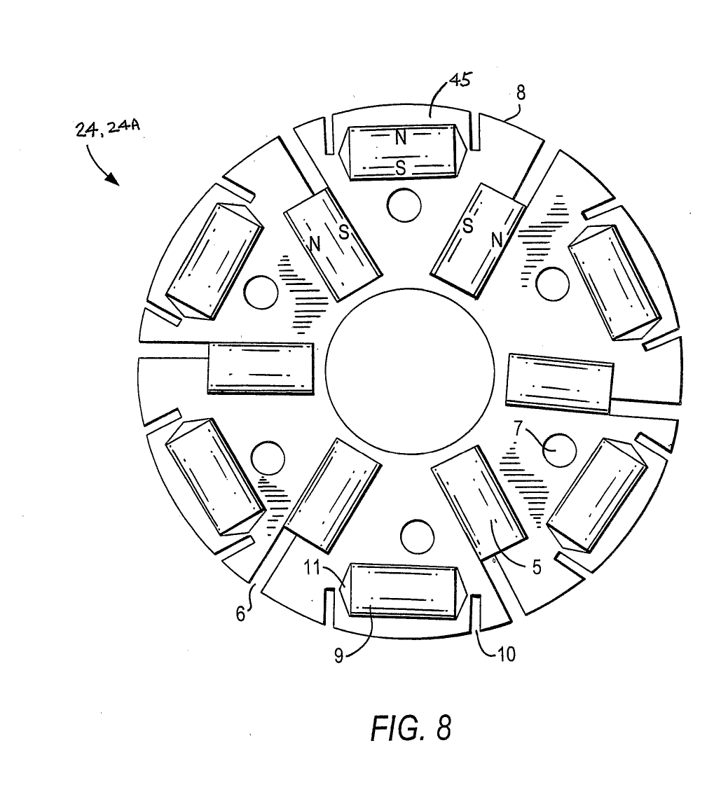

Embodiment 4 of this invention is shown in FIG. 7, FIG. 8. 1 shows electrical rotary machinery; 24, 24a, 24b, rotor; 3, stator; 45 shows iron core magnetic pole comprising electromagnetic steel plate in rotor 24a, 24b. In electrical rotary machinery 1, the structure is such that on insertion of magnets 5, 9 in rotor 24 comprising magnets 5, 9, the interior side relative to radial magnet 5 and ringed magnet 9 has same poles in the “protruding part” 24a of rotor 24 comprising part of magnets 5, 9 longer than length in shaft direction of stator 3 comprising iron core by electromagnetic coupling of winding 16; interior side relative to radial magnet 5 and ringed magnet 9 has opposite poles in the “non-protruding part” 24b of rotor 24 comprising part of magnets 5, 9 shorter than length in shaft direction of stator 3 comprising iron core by electromagnetic coupling. By such structure, magnetic flux of “protruding part” 24a of rotor 24 is in the direction of the arrow; magnetic flux of “non-protruding part” 24b of rotor 24 is in the direction of the arrow. Therefore, magnetic flux of “protruding part” 24a of rotor 24 and magnetic flux of “non-protruding part” 24b reinforce each other. As the result of such structure, it is possible to devise large increase in magnetic flux in the air gap of rotor 24 and stator 3, almost proportional to the length of “protruding part” 24a, devise even larger marked increase in performance of electrical rotary machinery 1, reduce torque cogging phenomenon, suppress vibration, and obtain even greater effects. In this situation, when iron core 23, which is independent and used exclusively for strengthening magnetic field of trailing edge portion 8 of rotor magnetic pole 45 in the Embodiment, is coupled with the trailing edge portion in the shaft direction opposing iron core section of stator, and magnetic flux is additionally strengthened from the protruding part, rapid improvement in additional driving force is possible at time of synchronous rotation.

As the result, even when electrical rotary machine 1 comprises a small-size electric motor, additional efficiency increase of 3˜5% is possible; high efficiency of 95˜98% is obtained. Further, in the case of electrical rotary machine 1 of same output capacity, in comparison to conventional machinery, even more downsizing can be devised.

### POSSIBLE INDUSTRIAL APPLICATIONS

As examples of this invention in practical use, range of very broad utilization is possible, in general industrial equipment, household electrical apparatus, automotive and vehicular apparatus, medical apparatus, electrical equipment for wind power, water power, thermal power, etc.

Changes may be made in the embodiments of the invention described herein, or in parts or elements of the embodiments described herein, or in the sequence of steps of the methods described herein, without departing from the spirit and/or scope of the invention as defined in the following claims.

1. An electrical rotary machine using magnets comprising a rotor assembly facing a stator assembly for providing rotary driving force, said rotor assembly having a trailing edge portion for each of rotor magnetic pole configurations, said trailing edge portion adapted to have a strong magnetic field and create additional rotary driving force during synchronous rotation in association with both same and opposite magnetic poles of a stator facing the trailing edge portion of the rotor magnetic pole configuration.

2. An electrical rotary machine using a rotor, a stator and magnets, comprising a rotary assembly provided with radial or ringed magnets on insertion of magnets in the rotor, wherein each of magnetic pole configurations of the rotor is broad in width toward magnetic pole configurations of the stator along the rotation surface and has a trailing edge portion maintaining relative positions with the stator magnetic pole configuration, constantly with during synchronous rotation, normally enabling suction and repulsion by means of the stator magnetic pole configurations opposing around the rotor magnetic pole trailing portions, whereby rotary driving force is additionally increased.

3. An electrical rotary machine using a rotor, a stator and magnets, wherein each of rotor magnetic pole configurations comprising the magnets has varying angular pitch widths, wherein each of the rotor magnetic pole configurations has radial and ringed magnets on insertion of magnets in said rotor and a trailing edge portion including an air gap or non-magnetic member part around all of these magnets so that magnetic flux of ringed magnets of said rotor does not return directly to said rotor magnets, magnetic flux in the air gap is rapidly increased, thereby eliminating cogging without providing skew by relative deflection of angular positions toward stator magnetic pole comprising electromagnetic coupling, and wherein the trailing edge portion of each of the rotor magnetic pole configurations constantly maintains relative positions with the stator magnetic pole configuration during synchronous rotation and, enabling suction and repulsion during rotation by means of the stator magnetic pole configurations opposing against the trailing edge portions of the rotor magnetic pole configurations, rotary driving force is additionally increased.

4. An electrical rotary machine using a rotor, a stator and magnets, wherein each of magnetic pole configurations of the rotor is provided with radial or ringed magnets on insertion of magnets in the rotor and wherein the rotor is subdivided into multiplicity such as cutting in round slices in the shaft direction of said rotor, wherein one part of subdivided rows in rotor is independently strengthened as a trailing edge portion of the rotor magnetic pole configuration and, at the time of synchronous operation, constantly maintains relative positions between the independently strengthened rotor magnetic pole trailing edge portions and the stator magnetic pole configuration, thereby normally enabling suction and repulsion by means of stator magnetic poles opposing front and rear of the trailing edge portion of the rotor magnetic pole configuration, the resultant effect is that of additionally increasing rotary driving force as possible.

5. An electrical rotary machine using a rotor, a stator and magnets, wherein the rotor is structured such that on insertion of magnets in the rotor, the interior sides relative to radial and ringed magnets have as same poles in the protruding part of rotor comprising part of magnet longer than length in shaft direction of the stator comprising iron core by electromagnetic coupling and the interior sides relative to radial and ringed magnets have opposite poles in the non-protruding part of rotor comprising part of magnet shorter than length in shaft direction of stator comprising iron core by electromagnetic coupling, and wherein magnetic flux in the air gap at trailing edge portion of rotor magnetic pole configuration at iron core end section of the rotor is rapidly increased, and wherein the trailing edge portion of the rotor magnetic pole configuration constantly maintains relative positions with the stator magnetic pole configurations during synchronous rotation, normally enabling suction and repulsion very strongly by means of the stator magnetic pole configuration opposing front and rear of the trailing edge portion of the rotor magnetic pole configuration, whereby rotary driving force is additionally increased as possible.

6. An electrical rotary machine using magnets, comprising a rotor provided with radial or ringed magnets on insertion of magnets in the rotor, wherein magnetic pole configuration of the rotor is broad in width toward magnetic pole of the stator, and constantly maintains relative positions during synchronous rotation, between the rotor magnetic pole trailing edge portion and the stator magnetic pole, normally enabling suction and repulsion by means of stator magnetic pole opposing the front and rear of rotor magnetic pole trailing edge portion, thus additionally increasing rotary driving force.

7. An electrical rotary machine comprising a rotor, a stator and magnets, the rotor provided with radial and ringed magnets on insertion of magnets in said rotor, wherein rotor magnetic pole configuration has varying angular pitch widths, eliminating cogging without skew by relative deflection of angular positions toward stator magnetic pole comprising electromagnetic coupling, at the same time preventing decrease in magnetic flux in the air gap, and wherein there is provided an air gap or non-magnetic member part around said magnets at trailing edge portions of the rotor magnetic pole configuration so that magnetic flux of ringed magnets of said rotor does not return directly to said rotor magnets, and wherein there is constantly maintained relative positions during synchronous rotation, between the rotor magnetic pole trailing edge portion and the stator magnetic pole, normally enabling suction and repulsion by means of magnetic poles at front and rear of stator, opposing front and rear of rotor magnetic pole trailing edge portion, thus additionally increasing rotary driving force.

8. An electrical rotary machine using a rotor, a stator and magnets, comprising radial and ringed magnets on insertion of the magnets in the rotor, wherein the rotor is subdivided into multiplicity in the shaft direction of said rotor, wherein one part of row comprising rotor structure is independently strengthened as rotor magnetic pole trailing edge portion, and wherein there is constantly maintained relative positions during synchronous rotation, between the rotor magnetic pole trailing edge portion and the stator magnetic pole, normally enabling suction and repulsion during rotation by means of magnetic poles at front and rear of stator, opposing front and rear of rotor magnetic pole trailing edge portion, thus additionally increasing rotary driving force.

9. The electrical rotary machine in claim 2, 3 or 4, wherein the interior sides relative to radial and ringed magnets have same poles in the protruding part of rotor comprising part of magnet longer than length in shaft direction of stator comprising iron core by electromagnetic coupling, and the interior sides relative to radial and ringed magnets have opposite poles in the non-protruding part of rotor comprising part of magnet shorter than length in shaft direction of stator comprising iron core by electromagnetic coupling, thus increasing magnetic flux in air gap according to amount of protrusion.

10. The electrical rotary machine in claim 2, 3 or 4, adapted to be scaled up to be applicable to a mobile machine such as large-capacity apparatus and linear motor by replacing rotor magnet section with superconducting electromagnetic coil and the like.

11. The electrical rotary machine in claim 2 or 4, wherein improvement is made possible in performance by removing one section of magnets in radial and ringed magnet sections, and the magnetic force of magnets is adjusted to adjust the magnetic field of the asymmetrically configured magnetic pole section provided on the rotor.

12. The electrical rotary machine in any one of claims 1 to 7 wherein the stator and rotor are reversed to enable rotation of stator side to become rotor, on the other hand, for stator from the rotor side formed into magnetic pole by magnets opposing stator, and external electricity is supplied to rotor by slip ring and additional driving force is generated by driving at synchronous speed.

13. The electrical rotary machine in any one of claims 1 to 7 wherein the stator magnetic pole comprises magnets, and additional driving force is generated by enabling rotation and driving at synchronous speed by means of another prime mover.

14. The electrical rotary machine in any one of claims 1 to 8 wherein controller and prime mover are separated for actuation during the operation itself, eliminating operating loss from these to display maximum efficiency.

15. The electrical rotary machine in any one of claims 1 to 8, wherein controller and prime mover are separated for actuation from the operation during operation, stopping completely when abnormality such as excess load occurs during operation and is not corrected by repeatedly restarting several times for a short time.
